(19) United States
(12) Patent Application Publication
(10) Pub. No.: US 2005/0206782 A1
(43) Pub. Date: Sep. 22, 2005

(54) Television receiver including limiter circuit that prevents occurrence of smearing

(75) Inventor: Shiro Miyawaki, Takefu-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 11/062,449

(22) Filed: Feb. 22, 2005

(30) Foreign Application Priority Data
Mar. 16, 2004 (JP) 2004-074232

(51) Int. Cl. H04N 5/63

(52) U.S. Cl. 348/380; 348/730

(57) ABSTRACT

The object of the invention is to provide a television receiver including a limiter circuit capable of preventing occurrence of smearing right after the receiver is turned on. The invention provides a television receiver having a limiter circuit provided with a time constant circuit on a power supply line for supplying a power to the limiter circuit that limits a beam current carried to a color cathode-ray tube by detecting the beam current carried to the color cathode-ray tube and controlling a level of at least one of a contrast and a brightness of a video signal so as to delay supply of the power to the limiter circuit, thereby preventing occurrence of the smearing on a display screen right after the receiver is turned on.

### BACKGROUND OF THE INVENTION

1. Field of the Invention

The present invention relates to a television receiver including a limiter circuit that prevents occurrence of smearing right after the color television receiver using a color cathode-ray tube (CRT) is turned on.

2. Description of the Related Art

It is well known that streaks or so-called smear in a picture on a display screen occurs because a heater of a color CRT of a color television receiver does not sufficiently generate a heat right after the color television is turned on and heat emission of the heater is insufficient. The smearing occurs when a cathode of the color CRT is cold and a video signal has a strong contrast.

To solve the disadvantage, Patent Literature 1 discloses a control method using a microcomputer program for suppressing a contrast value right after a television receiver is turned on to be lower than an initial set value that is preset as a contrast value during ordinary viewing, and gradually increasing the contrast value up to the initial set value, thereby preventing occurrence of smearing right after the television receiver is turned on.

Patent Literature 2 discloses that a time constant circuit composed by a resistor, a capacitor and a transistor is provided in a video amplification circuit, and a television receiver is controlled so that a voltage amplification factor of a video output circuit is reduced right after a television receiver is turned on and so that the amplification factor is returned to a normal voltage amplification factor after a passage of a predetermined time since the television receiver is turned on, thereby preventing occurrence of smearing right after the television receiver is turned on.

Patent Literature 1: Japanese Patent Application Laid-Open No. 2001-45402

Patent Literature 2: Japanese Patent Application Laid-Open No. 7-7700

These conventional techniques can prevent occurrence of the smearing on the display screen right after the television receiver is turned on. However, the method using the microcomputer program as typically disclosed in the Patent Literature 1 disadvantageously needs to prepare the microcomputer program. Further, if a user temporarily turns off the television receiver for some reason wile the user is actually viewing a television program and turns on the television receiver again soon after turning off the television receiver, the contrast value right after the television receiver is turned on again is forced to be suppressed to be lower than the initial set value by the microcomputer program although the cathode of the color CRT is sufficiently heated by a remaining heat. As a result, the contrast of a picture displayed on the screen is disadvantageously reduced.

Although the conventional technique disclosed in the Patent Literature 2 does not have the disadvantage when the microcomputer program is used, the following disadvantage occurs. Since the time constant circuit is provided in the video amplification circuit, it is necessary to prepare a dedicated wire for connecting substrates so as to carry a current to the time constant circuit. The disadvantage of the invention disclosed in the Patent Literature 2 will be described in more detail with reference to the drawings.

FIG. 1 is a block diagram which depicts an ordinary video output circuit of a color television receiver. The video output circuit is composed by a power supply 1, a microcomputer 2, a video signal processing circuit 3, a video amplification circuit 4, a vertical output circuit 5, a horizontal output circuit 6, a flyback transformer (“FBT”) 7, a color CRT 8, and an auto-contrast limiter (“ACL”) input circuit 9. FIG. 2 depicts one example of a circuit diagram of a conventional ACL input circuit. A point A is connected to an auto-brightness limiter (“ABL”) terminal 13 of the FBT 7. A voltage according to a beam current carried to the color CRT is detected by detection resistors R5 and R6. When the beam current carried to the color CRT is increased, that is, a picture displayed on a display screen is a bright picture, the voltage at the point A is reduced. When the beam current carried to the color CRT is reduced, that is, the picture displayed on the display screen is a dark picture, the voltage at the point A is increased. A voltage at a point B obtained after the detected voltage is adjusted by resistors R1, R2, R3, and R4 is input to an ACL input terminal 12 of the video signal processing circuit 3. The video signal processing circuit 3 controls a contrast of the video signal according to the voltage input from the ACL input terminal 12. Namely, the video signal processing circuit 3 includes an ACL circuit that controls the contrast of the video signal to be reduced when the beam current carried to the color CRT 8 is increased, thereby limiting the beam current carried to the color CRT 8. As for an integrated circuit (IC) for the video signal processing, not only the video signal processing IC including the ACL input terminal as described above but also a video signal processing circuit IC including an ABL input terminal and a video signal processing circuit IC including an auto brightness contrast limiter (“ABCL”) input terminal have been put to practical use. Using such an IC including the ABL input terminal or the ABCL input terminal, an ABL circuit or an ABCL circuit is constituted. The ABL circuit controls a brightness of the video signal and the ABCL circuit controls both the brightness and the contrast of the video signal, thereby controlling the beam current carried to the color CRT.

The invention disclosed in the Patent Literature 2 is intended to delay rising of a voltage to be applied to the cathode of the color CRT 8 and thereby prevent occurrence of smearing right after the television receiver is turned on by providing the time constant circuit composed by the resistor, the capacitor, and the transistor in the video amplification circuit 4 in FIG. 1. FIG. 4 is a circuit diagram of the video amplification circuit including the time constant circuit according to the Patent Literature 2 (referred to as “power-ON time smearing elimination circuit” in the Patent Literature 2). While only the time constant circuit for B is shown in FIG. 4, time constant circuits for R and G, not shown, are similarly necessary. In addition, a cable that is a dedicated wire for supplying a voltage of 12 volts to be applied to these time constant circuits is necessary.

### SUMMARY OF THE INVENTION

The present invention has been achieved to solve the conventional disadvantages. It is an object of the present invention to provide a limiter circuit for a color television receiver capable of dispensing with a wire for carrying a current as required in the Patent Literature 2, capable of solving the disadvantage of the Patent Literature 1 that a contrast is reduced on a display screen if a user temporarily turns off the receiver for some reason and turns on the receiver again right after turning off the receiver, and capable of preventing occurrence of smearing right after the receiver is turned on when the user views a program using the color television receiver, and to provide the color television receiver including the limiter circuit.

According to a first aspect of the present invention, there are provided a limiter circuit, for limiting a beam current carried to a color cathode-ray tube by detecting the beam current carried to the color cathode-ray tube, and controlling a level of at least one of a contrast and a brightness of a video signal, wherein a time constant circuit composed by a resistor, a capacitor, and a transistor is provided on a power supply line for supplying a power to the limiter circuit, so as to delay supply of the power to the limiter circuit, thereby preventing occurrence of smearing on a display screen right after the power is turned on, and a television receiver including the limiter circuit. According to a second aspect of the present invention, there is provided a television receiver using a color cathode-ray tube, comprising: an auto-contrast limiter circuit or ACL circuit, an auto-brightness limiter circuit or ABL circuit, or an auto brightness contrast limiter circuit or ABCL circuit constituted so that a voltage detected at an ABL terminal of a flyback transformer or FBT is input to an ACL input terminal, an ABL input terminal, or an ABCL input terminal of a video signal processing integrated circuit or video signal processing IC, wherein a time constant circuit composed by a resistor, a capacitor, and a transistor is provided on a power supply line for supplying a power to an input level adjustment resistor, which resistor adjusts an input level of the power input to the ACL input terminal, the ABL input terminal, or the ABCL input terminal of the video signal processing IC so as to reduce the voltage input to the ACL input terminal, the ABL input terminal, or the ABCL input terminal of the video signal processing IC right after the television receiver is turned on, thereby preventing occurrence of smearing on the display screen right after the television receiver is turned on.

According to the present invention, the limiter circuit that limits the beam current carried to the color cathode-ray tube and that is constituted so that the time constant circuit composed by the resistor, the capacitor, and the transistor is provided on a power supply line for supplying a power to the limiter circuit, so as to delay supply of the power to the limiter circuit, thereby preventing occurrence of smearing on a display screen right after the color television receiver is turned on is provided. It is thereby possible to dispense with a dedicated wire for connecting substrates for carrying a current, and to prevent occurrence of the smearing on the display screen right after the television receiver is turned on if the user temporarily turns off the receiver for some reason and turns on the receiver again right after turning off the receiver.

### BRIEF DESCRIPTION OF THE DRAWINGS

FIG. 1 is a block diagram that depicts an ordinary video output circuit of a color television receiver;

FIG. 2 is a circuit diagram of a conventional ACL circuit;

FIG. 3 is a circuit diagram of an ACL circuit that includes a time constant circuit for explaining an embodiment of the present invention; and

FIG. 4 is a circuit diagram of a conventional video amplification circuit that includes a time constant circuit.

### DESCRIPTION OF THE PREFERRED EMBODIMENT

An exemplary embodiment of the present invention will be described hereinafter with reference to the drawings.

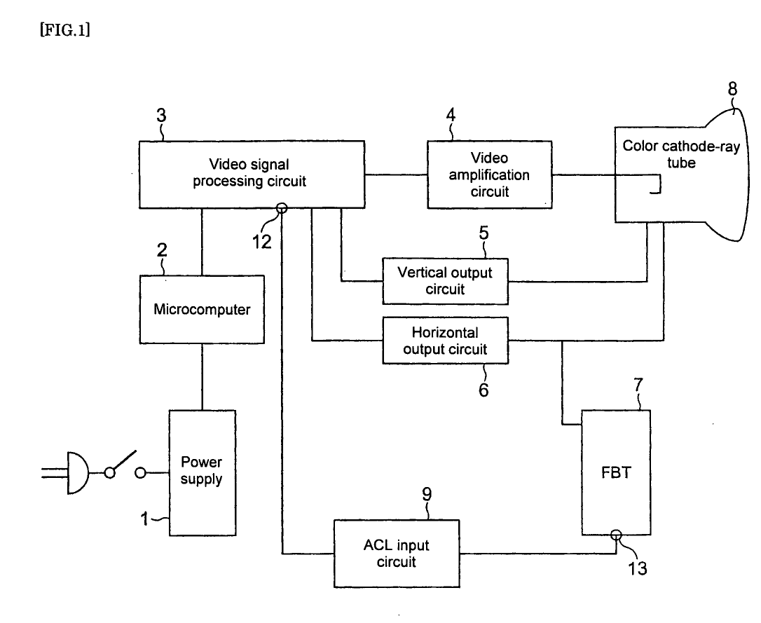

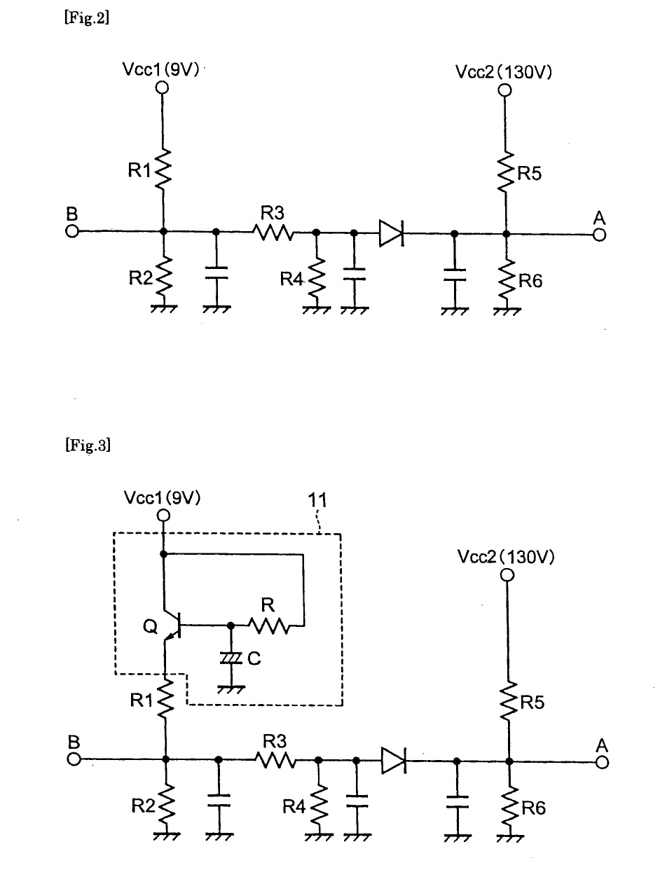

FIG. 1 is a block diagram which depicts an ordinary video output circuit of a color television receiver. The video output circuit is composed by a power supply 1, a microcomputer 2, a video signal processing circuit 3, a video amplification circuit 4, a vertical output circuit 5, a horizontal output circuit 6, a flyback transformer (“FBT”) 7, a color cathode-ray tube (CRT) 8, and an auto-contrast limiter (“ACL”) input circuit 9.

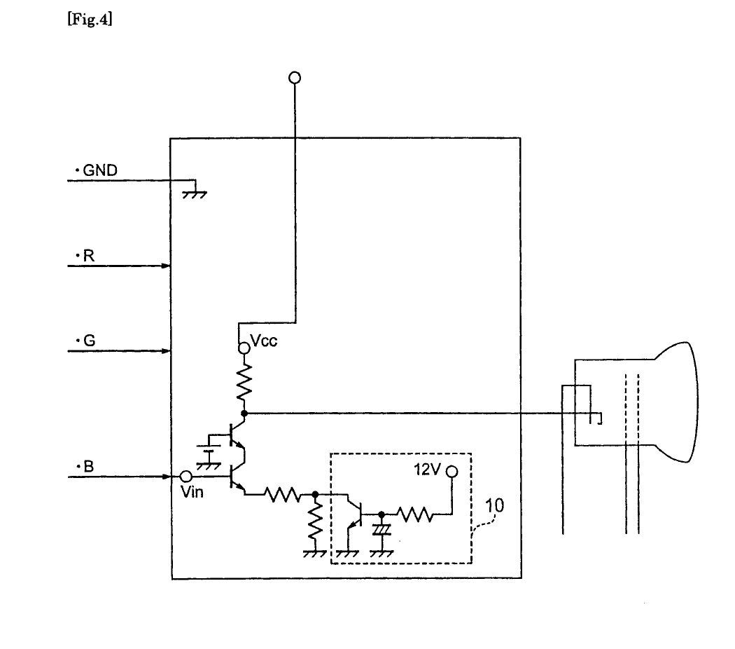

According to the present invention, as an ACL input circuit 9 shown in FIG. 1, a time constant circuit 11 composed by a resistor R, a capacitor C, and a transistor Q is provided on a power supply line for supplying a power to an input level adjustment resistor R1 as shown in FIG. 3, so that the time constant circuit 11 composed by the resistor R and the capacitor C can delay a time at which the transistor Q is turned on when the power supply 1 of the color television receiver is turned on. It is, therefore, possible to delay a timing of starting applying a voltage Vcc1 of 9 volts to the input level adjustment resistor R1. In addition, while the voltage Vcc1 is not applied to the input level adjustment resistor R1, a voltage at a point B can be reduced as compared with the voltage while the Vcc1 is applied to the input level adjustment resistor R1. Namely, by controlling the color television receiver to reduce the voltage at the point B, to reduce the voltage input to the ACL input terminal 12 of the video signal processing circuit 3, and to reduce a contrast of a video signal, the contrast of the video signal on a display screen of the color CRT 8 can be reduced and occurrence of smearing on the display screen when the color television receiver is turned on can be prevented. In this embodiment, the instance of providing the ACL input terminal 12 on the video signal processing circuit 3 has been described. Alternatively, an ABL input terminal or an ABCL input terminal may be provided on the video signal processing circuit 3. If the ABL input terminal is provided on the video signal processing circuit 3, a brightness of the video signal is controlled to be reduced. If the ABCL input terminal is provided on the video signal processing circuit 3, both the brightness and the contrast of the video signal are controlled to be reduced. It is thereby possible to prevent occurrence of smearing on the display screen when the color television receiver is turned on.

1. A limiter circuit for a color television receiver, for limiting a beam current carried to a color cathode-ray tube by detecting the beam current carried to the color cathode-ray tube, and controlling a level of at least one of a contrast and a brightness of a video signal, wherein
a time constant circuit composed by a resistor, a capacitor, and a transistor is provided on a power supply line for supplying a power to said limiter circuit, so as to delay supply of the power to said limiter circuit, thereby preventing occurrence of smearing on a display screen right after the power is turned on.

2. A television receiver including the limiter circuit according to claim 1.

3. A television receiver using a color cathode-ray tube, comprising:
an auto-contrast limiter circuit or ACL circuit, an auto-brightness limiter circuit or ABL circuit, or an auto brightness contrast limiter circuit or ABCL circuit constituted so that a voltage detected at an ABL terminal of a flyback transformer or FBT is input to an ACL input terminal, an ABL input terminal, or an ABCL input terminal of a video signal processing integrated circuit or video signal processing IC, wherein
a time constant circuit composed by a resistor, a capacitor, and a transistor is provided on a power supply line for supplying a power to an input level adjustment, which resistor adjusts an input level of the power input to the ACL input terminal, the ABL input terminal, or the ABCL input terminal of said video signal processing IC so as to reduce the voltage input to the ACL input terminal, the ABL input terminal, or the ABCL input terminal of said video signal processing IC right after the color television receiver is turned on, thereby preventing occurrence of smearing on the display screen right after the color television receiver is turned on.
